(19) United States
(12) Patent Application Publication
(10) Pub. No.: US 2012/0197815 A1
(43) Pub. Date: Aug. 2, 2012

(54) System for allocating fundraising

(75) Inventors: Jon Cameron, Dallas, TX (US); Alice Higgins, Irving, TX (US); Kevin Lippincott, Dallas, TX (US)

(73) Assignee: David Dunlap, LLC, Dallas, TX (US)

(21) Appl. No.: 13/385,771

(22) Filed: Mar. 6, 2012

(51) Int. Cl. G06Q 40/00

(52) U.S. Cl. 705/329

(57) ABSTRACT

A fundraising system (10) allowing donors (100) to identify, target and contribute to multiple recipient groups (150) within a primary institution (130). These recipient groups (150) can include the primary institution (150), legally associated entities (151), outside recipients of funds (152) from the primary institution, volunteers (160), and individuals served (170).

### BACKGROUND

1. Field of Invention

The invention is related to the fundraising system and method for a sponsor to allocate donations to groups supported by a primary institution.

2. Background of the Invention

The present invention provides donors with enhanced capability to identify and target specific recipients within a parent institution. This provides entirely new capabilities to supporters for determining the final destination of their funds.

Professional Fundraising Systems

Today, professional donation management systems center on client relationship management (CRM) which is a set of practices, processes and systems which allow donor recipients to track and retain donors. Average donor retention is about thirty percent which demonstrates that charities have a far better record of attracting new donors than of systematically managing existing, or former, supporters. The objective of these fundraising CRM systems is to track specifics about donors such as contact information, preferred types of contact, and donor scoring which should improve retention rates and maximize individual donations. Examples of these types of donor management systems include DonorPerfect, FundRaiser Software, Blackbaud Fundraising Software.

There are several other classifications of software designed to aid organizations in fundraising activities:

Payment Processing—Software designed to handle electronic funds transfers, automated clearinghouse payments and credit cards. These systems can be stand-alone or integrated with other fundraising management systems such as CRM.

Grant Management—Handles the unique complexities of grants including tracking key dates, grant requests, and status.

Pledge Management—Focus on tracking compliance for future donations including pledge reminder, delinquency notices, and tracking pledged balances.

Gift Management—Processes designed to track physical gifts such as in-kind donations of goods and services, and matching gifts.

Other niche software types include reporting modules; mailing applications; event and volunteer logistics; and membership management.

Notable about this list of professional fundraising systems is that all the tools are designed for use by fundraising professionals seeking funds and charitable gifts. The systems are not designed to be used by donors. Professional fundraising software provides benefits to the organizer, not the donor.

What is missing from this list of existing professional fundraising systems is an interactive donor system which allows the donor to actively manage and target donations within tiered organizations which can include the primary institution, affiliated groups and volunteers.

Online Fundraising Systems

Site Management—These software applications provide the capability to the organizer for a donation webpage creation, content management, tax receipts generation, and payment processing. Typical customizations include the ability for login donors to associate themselves with a group of donors, offer pledge opportunities and donate with non-monetary gifts. This software is geared toward soliciting donations for a single beneficiary.

Charity Auction—Software for publishing fundraising website which allows donors to place bids on goods and services. These goods and services may include gifts to the organizer or have been purchased by the organizer.

Donate by Shopping Online—These modules attach themselves to commercial websites and allow the website to engage in cause marketing. The consumer is advised that a percent of the purchase will be donated to a specific charity or a single organization of the consumer's choice. Systems that allow consumers to specific a charity have not been well-adopted by online retailers for two reason. One, these modules add complexities to the shopping cart which is seen as undesirable. Two, brand managers prefer using a pre-identified charity to provide the additional benefit of a brand halo where characteristics of the charity influence buyer's perception of the brand. If a brand does not provide a choice to the consumer, then a separate fundraising module is not required.

Ticketing Systems—These online interfaces are useful when donations are made through event attendance. The systems typically offer the ability to have different priced tickets, seating selection, payment acceptance, and charitable receipt for taxes. They are nearly identical to ticket selling software used by non-profits such as concerts and art exhibits.

Online fundraising systems that engage the donor have very similar and simple designs which allows the sponsor to quickly navigate the site and make a donation or pledge. The configurations allow the contributor to:
Select a donation amount from a list or enter another amount
If the payment is one-time or recurring
Identify matching gift donors such as a donor's employer
Billing Information
The name of the person who is to “honored” such as for a gift
The name of a person the gift is given in memorial.

Online fundraising software is typically hosted by the organizer, but new tools are becoming available which allow a hosting site to provide the functionality for multiple unrelated charities on a single server pool. This “cloud” solution provide multiple benefits by allowing sponsors to upload logos, choose design themes, and select pre-authorized payment choices. This also enhances site security, and reduces organization risk, since secure payment information is not available to the organizer.

By its nature, online fundraising software is donor facing so the donor actively engages the software to make a donation, participate in an auction, or buy event tickets. This is distinguished by professional fundraising software which is designed to be used by the organizer of the fundraising activity. However, the features of these online fundraising applications primarily benefit the organizer and have proven to provide significant increase in total donations, contributions, and pledges over events without an online presence. There are secondary benefits to the donor by allowing an easily locatable, accessible and fast payment system.

Charity Selection Systems

Online software also includes databases with the ability to select a charity based on a set of criteria are also well-known in the fundraising art. These systems are reasonably standardized in their approach to suggesting a charity by having the donor select a category; such as Animals, Art & Culture, Health, and Human Services; and then choosing geography, such as a city or state.

Notable is that these selection systems are not designed to pinpoint charities based on the individuals the charities serve, such as mothers, single mothers, poor single mothers, single mothers of teenagers and Puerto Rican single mothers.

These charity selection systems also have a distinct inability to target charities based on the participating volunteer classifications, for instance, college students, marathoners, professional athletes, zip code residents, teachers, art patrons, federated groups, seniors and elementary school children. This is useful for corporate donors to efficiently distribute funding while also providing advertising to targeted groups.

### SUMMARY OF THE INVENTION

An invention, which meets the needs stated above, is a system and method which allows donors to provide contributions to a primary institution and any group or individual who receives funding from the primary institution.

An example of the challenges the current invention addresses occurred in February 2012 with the Susan G. Komen Foundation (SGKF). The foundation made an announcement which surprised both the media and donors. They announced that would no longer provide funds for cancer screening to Planned Parenthood Federation of America (PPFA). The astonishment was primarily that SGKF was funding cancer screening at PPFA. While sponsors were previously unaware PPFA was an outside recipient of funds, the new exclusion drew a deep division within both the supporters and the individuals the discrete groups served.

The donor backlash after the announcement caused SGKF to reverse its decision but this did little to abate a public relations crisis. For many in the fundraising industry, this incident highlighted the importance of donor visibility into a tiered organization, and that donors wanted to have a voice on how those funds were distributed to discrete groups after they made their initial donation to the primary institution. For many donors, this was the first time they considered where their donations were being allocated within a tiered organization.

A second example, in 2010, PepsiCo's Frito-Lay North America business unit announced a “Score for Your School” program for Texas schools. The philanthropic promotion required consumers to vote with a purchased packaged of PepsiCo products. A consumer would go to a designated website, enter a product's UPC, and select a school. Using the present invention, the resulting data could then be associated to target specific schools with the Texas school system and provide donations in a systematic series of tactics. For instance, PepsiCo has different profile for consumers who purchase, for example, Diet Mountain Dew 2 L or Mountain Dew Cherry 12 PK cans. Using geodemographic profiling tools, any brand can roll up this consumption data to create a profile associated with a group of individuals of a specific school within a tiered organization.

In the present invention, the donor then uses the profiles of the humans associated with a discrete group. This allows brands to segment and target schools within the Texas system who have a propensity of geodemographic characteristics appropriate to grow the sponsoring brand. This is a markedly different approach than a consumer brand would use today to target subgroups in a tiered organization for donations. Today, the characteristics of sub groups are used instead of the characteristics of the volunteers or individuals served.

### OBJECTS AND ADVANTAGES

Accordingly, besides the objects and advantages of the system for allocating fundraising, further objects and advantages are:
a. Provides donor visibility of discrete groups within the primary institution. A donor who is providing funds to an organization would be able to interactively view all the entities receiving portions of those funds.
b. Provide sponsor visibility to remaining needs of discrete groups including identifying groups with no remaining funding requirements.
c. Allow supporters to target donation splits across a tiered organization. For instance, the ability to contribute to state school board, district, specific schools, and groups within the individual schools.
d. Allow donors to filter beneficiaries based on the geodemographics of the volunteers. As an example, a sponsor may provide advertising content designed to reach a specific volunteer profile.
e. Using dynamic data filters, allow contributors to identify discrete groups that serve a specific demographic within a tiered organization. For instance, a pharmaceutical manufacturer can target groups serving patients with specific disease.
f. Allow sponsors to compensate for-profit vendors, such as instructional material publishers, within a tiered organization. This would allows supplier of essential goods and services to be directly compensated through the tiered organization.
g. Allow donors to target specific volunteers based on a surrogate demographic. As an example instead of identifying specific teenager demographics, the filter would target these individuals using the household profile of the parent(s).
h. Predetermine donor eligibility for each discrete groups within the tiered organization so that only eligible discrete groups would be displayed. For instance, an adult beverage supplier may only see discrete groups with volunteers above the legal drinking age.

Further objects and advantages of this invention will become apparent from a consideration of the drawing and the ensuing description of the drawings.

### DRAWING FIGURES

The accompanying drawings, which are incorporated in and constitute a part of this specification, illustrate embodiments of the present invention and together with the description, serve to explain the principles of this invention. In the figures;

FIG. 1—Example flow chart depicts fundraising system of the present invention for the selection of discrete groups within the primary institution and the subsequent donation split to discrete groups.

FIG. 2A—Example of Tiered Organization

FIG. 2B—Second Example of Tiered Organization

FIG. 3A—Drawing showing the elements of a basic system which allows the donor to allocate contributions.

FIG. 3B—Drawing showing the elements of a system which allows the donor to allocate contributions based on the profile of the members of discrete groups.

FIG. 3C—Drawing showing the elements of a system which allows the donor to allocate contributions based on the profile of the individual served or their surrogate.

FIG. 3D—Drawings showing the component of an example system for allocating funds into a donation split.

### REFERENCE NUMERALS IN DRAWINGS

Fundraising System, Sponsorship System, System for Allocating Fundraising, Donor System
100 Sponsor, Donor, Contributors, Supporters
110 Donation, Contributions, Pledge, Funds
120 Tiered Organization
130 Primary Institution, Institution, Organizer, Parent Institution
140 Donation Split, Contribution Split, Share Split, Discrete Donation
150 Charity, Group, Discrete Group, Recipient, Donor Recipient, Beneficiary, Multiple Recipient Groups
151 Legally Associated Entities
152 Outside Recipient, Affiliated Group, For Profit
160 Volunteer, Educator
161 Surrogate, Volunteer Surrogate, Student's Parents
170 Individuals served, Individuals Served by Charity, Students, Served Individual
200 Data File (of Discrete Groups, Outside Recipients, Legally Associated Entities, Volunteers, Individuals Served and Surrogates)
210 Filter, Filter System
220 Demographic Profile System, Demographic Profile
221 Geodemographic Score Input
223 Input of Allocated Donation Funds
224 Discrete Groups Suggested, Discrete Groups Suggested and Selected
225 Allocation of Donation among Discrete Groupsc;

### DETAILED DESCRIPTION OF THE DRAWINGS

Referring to the drawings, in which like numerals represent like elements,

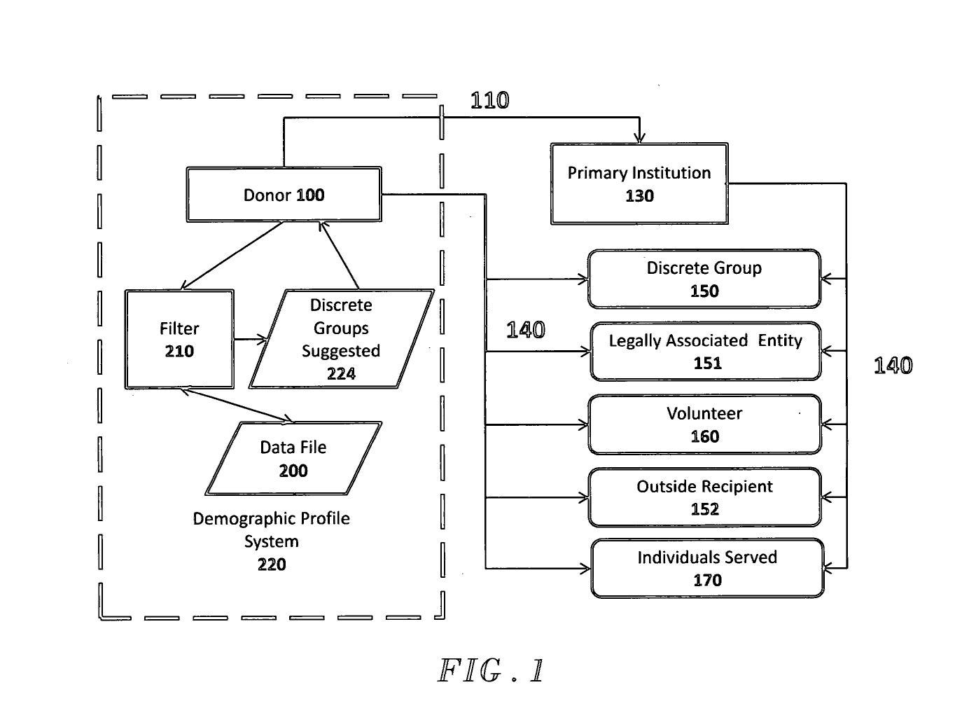

FIG. 1

Turning to FIG. 1, the logic flow chart depicts example Fundraising System 10 for the selection of discrete groups 150 within the primary institution 130 of a tiered organization 120 to receive a share split 140 of the donation 110 from the donor 100.

Fundraising systems 10 comprises systems and data for the identification of groups 150 or institutions 130 and the allocation of those funds 110 within the discrete groups suggested 224 by the system and selected by the donor 100. Fundraising systems 10 can comprise sponsorship systems, online systems, site management tools, auction functionality, contributions 110 management features, reporting capabilities, billing, payment processing, and donor 100 communication tools.

The present invention utilizes a computer-implemented interactive donor-facing tool which facilities the ability of donor 100 to efficiently and effectively provide discrete donations 110 in complex tiered organizations 120.

Donor 100, as used herein, comprises individuals, businesses, entities, charities, organizations, government entities, advertisers and content generators.

The donor 100 begins by accessing the fundraising system 10 with the first task of accessing the filter 210. The filter system 210 comprises various tools including demographic profile systems 220, geographic mapping, and institutional mapping. Combined, they create a geodemographic profiling system capable of sorting groups 150 based on the profiles of volunteers 160, surrogates 161, and individuals served 170.

The filter 210 is a computer-implemented system which accesses data files 200 comprising information on discrete groups 150; outside recipients 152; legally associated entities 151; primary institution 130 and the individuals associated with the entities. By using the demographic profile 220 of the various individuals associated with a group 150, the filter 210 indentifies discrete groups 150 with a high index of target individuals. This is differentiated from the prior art which uses the characteristics of the organization such as years in operation; name and address of primary contact, previous years' budget, number of individuals served 170, primary needs, etc.

After the donor 100 applies the interactive filter 210 to the data file 200, the demographic profile system 220 displays a set of discrete groups suggested 224. The donor 100 can select members of the discrete groups suggested 224 or all of the suggestions.

The next step in the System for Allocating Funding 10 is to the allocate the donation 110 into a donation split 140 among discrete groups 150, legally associated entity 151, volunteers 160, outside recipients 152, or even directly to individuals served 170.

Donations 110 may be comprised of currency, points, services, goods, digital content, intellectual property, a promise, or real estate.

In the preferred embodiment, the system apportions the discrete donations 140 and transmits the full donation 110 to the primary institution 130 within a tiered organization 120. After the transmission, the donation splits 140 can be automatically applied within the fundraising system 10 or transferred to a financial system within the primary institution 130.

A number of variations and modifications of the invention can be used. For example, instead of the donor 100 transferring the full donation 110 to the primary institution 130, the donor 100 may export the discrete groups suggested and selected 224 with the associated donation splits 140. The export can be any format comprising electronic data carriers such as electronic data interchange, application programming interface, analog transmission, radio frequency, data clearinghouses, and digital telecommunications. The export would then be used by the donor 100, or a third-party agent for the donor 100, to pay the donation splits 140 directly to the discrete groups 150 and bypass the financial systems of the primary institution 130.

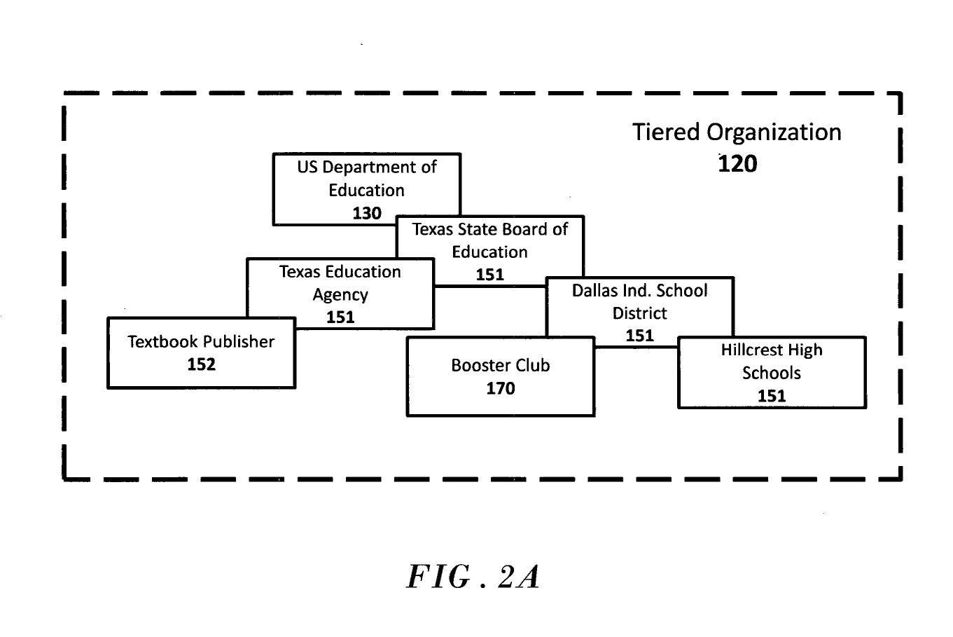

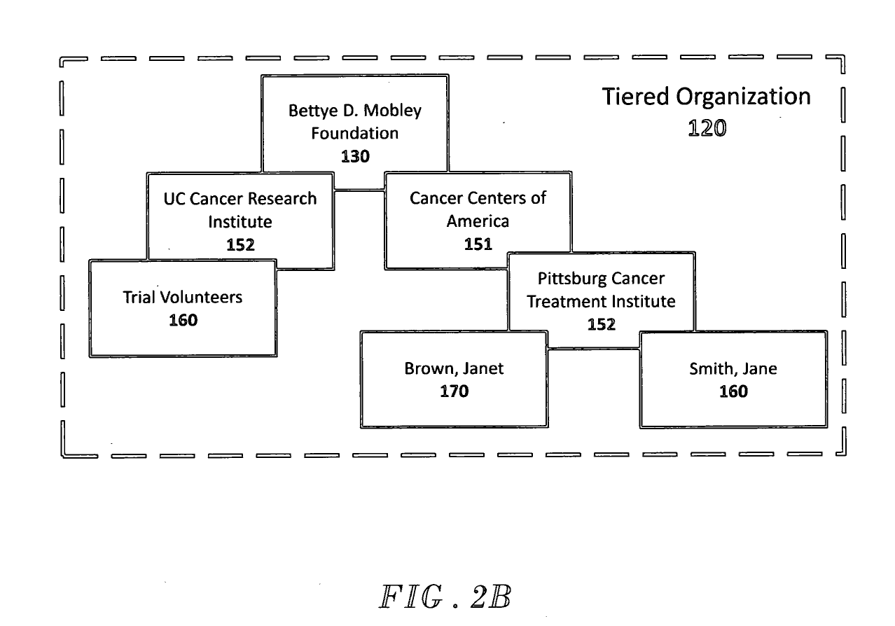

FIG. 2A

Referring to FIG. 2A, the organization chart depicts the structure of an example tiered organization 120. The depicted tiered organization 120 is typical of government organizations which provide for budget dissemination from state and federal revenue to local budgets.

Fundraising is conducted by educations organizations to augment budget limitations which are impacted by lawmaker sentiment, tax code modifications, and the economic performance of taxed individuals and organizations. Fundraising contributes to, or fully supports, programs such as intramural sports, special education, tutoring programs, travel, equipment, and educational materials.

In this illustration, the US Department of Education (USDE) is the parent institution 130 to the state agency Texas State Board of Education (TSBE), which is a legally associated entity 151 to the federal agency. Working left on the chart from the TSBE, the Texas Education Agency (TEA) is also a legally associated entity 151 to TSBE and their legal parent, the USDE. TEA is in charge of operations for the TSBE, and as part of that mandate, they provide educational materials, such as textbooks, to students 170. Therefore, they have the responsibility to distribute donations 110 to for-profit 152 entities including textbook manufacturers.

As each state has different organizational hierarchies, it is impossible for a fundraising system 10 to be uniformly organized on a national level if it is simply organized by traditional tiers. The present invention allows for donors 100 to allocate funds 110 at a national level by using filters 210 which focus on the demographic profile 220 of the student 170, the student's parents 161, or educators 160.

In a preferred embodiment of FIG. 2A, the donor 100 can access a national fundraising system 10 and locate schools 151 with students 170 who index high on a specific demographic profile 220 and then directly provide funds 110 to textbook manufacturers 152 for students 170 within the discrete groups suggested and selected 224 by the sponsor 100.

Moving to the right side of the illustration, the TSBE is a legal associated entity 151 to Dallas Independent School District (DISD). The DISD then has a legal association with Hillcrest High School (HCHS). In another preferred embodiment of FIG. 2A, the donor 100 can access fundraising systems 10 located at lower levels in the organizational chart. For instance, a fundraising system 10 provided by the DISD would filter 210 schools 151 located within the district 151 by using demographic profiles 220 of students 170, student surrogates 161 such as parents, or educators 160. For instance, a demographic profile 220 of a parental surrogate 161 with household income greater than $160,000, located in high density urban areas, college educated, with students ages 15-18 would identify HCHS as a beneficiary 150.

On the other hand, a similar demographic profile 220 of a household with income greater than $160,000, located in a high density urban area, college educated, ages 25-35 would identify the Booster Club at HCHS as a beneficiary 150.

FIG. 2B

Turning now to FIG. 2B, the organization chart depicts the structure of a second example tiered organization 120 with varied discrete groups 150 comprising legally associated entities 151, for-profit outside recipients 152, individuals served 170 and volunteers 160.

The parent institution in example FIG. 2B is the Bettye D. Mobley Foundation (BDMF) which receives funds 110 from large donors 100 with both political and economic interests they wish to protect and promote. The majority of the beneficiaries 150 of the BDMF are not legally associated with BDMF but remain as part of the primary institution's 130 tiered organization 120.

For purposes of illustration, the donor 100 is a pharmaceutical manufacturer with a cancer prevention drug with a target audience of females, ages 12-18.

Turning attention to the left side of the organizational chart: by applying a filter 210 to the volunteers 160 of each donor recipient 150 within the organizer 130, the donor 100 receives a list of charities 130 within BDMF's tiered organization 120. In this example, University of California Cancer Research Institute (UCCRI) is a for-profit institute which has a direct affiliation with BDMF, but no legal affiliation. UCCRI also conducts multiple drug trials with a high index of volunteers 160 matching the donor's 100 filter system 210.

Now turning attention to the right side of the organizational chart, by adjusting the filter 210 to both the individuals served 170, and volunteers 160, against each recipient group 150 within the organizer 130, the donor 100 receives a list of charities 130 within BDMF's tiered organization 120. In this example, BDMF is a legally associated entity 151 to Cancer Centers of America (CCA) as both a fundraiser and investor owner. CCA further provides a donation split 140 to Pittsburgh Cancer Treatment Institute (PCTI) as an outpatient follow-up treatment center. The filter 210 identified served individual 170 Janet Brown and volunteer 160 Jane Smith as ideal demographic profiles 220 which further identified their association with PCTI and CCA.

As a result of the demographic filter 210, for volunteers 160 and individuals served 170, within the donor system 10, the pharmaceutical contributor 100 was able to identify legally associated entities 151 and affiliated groups 152 within the Bettye D. Mobley's tiered charity organization 120.

In subsequent functions, the donor 100, or third-party vendor to the donor 100, would then be able to allocate a donation split 140 across any of the discrete groups 150 or targeted individuals: the primary institution 130, charities 150 supported by the primary institution 130, legally associated entities 151, outside recipients 152, volunteers 160 or individuals served by the charity 170.

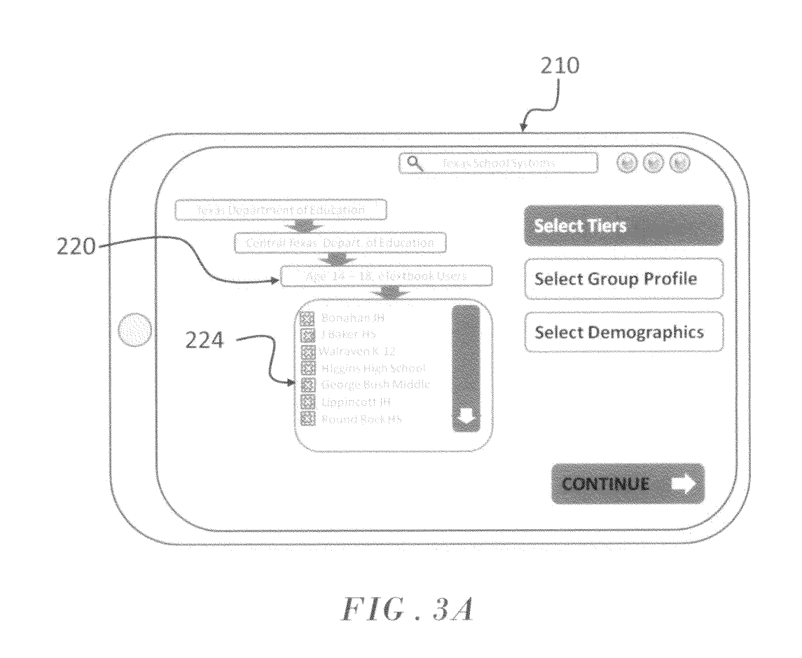

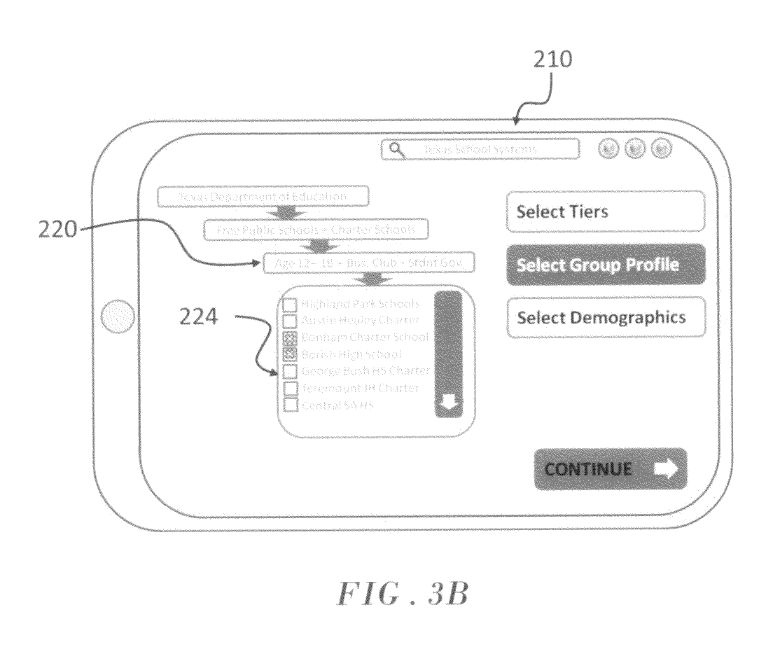

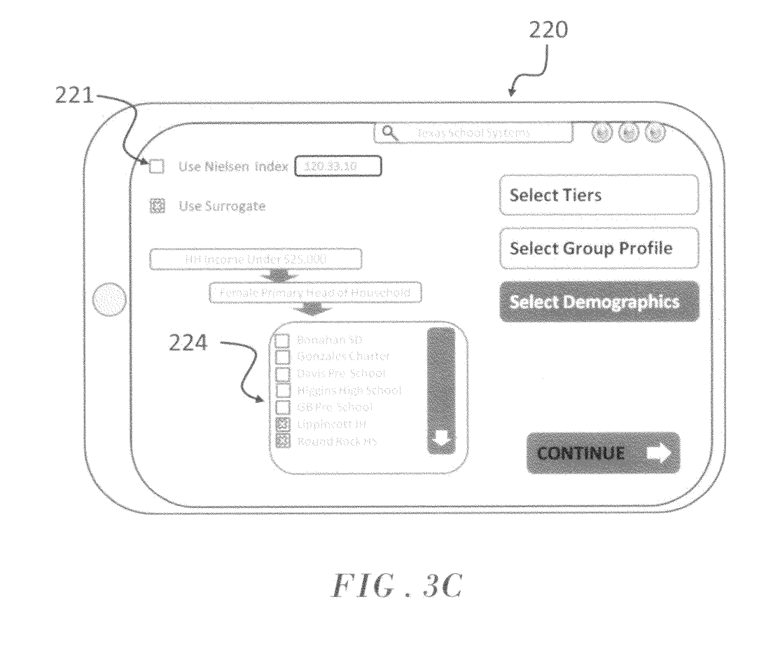

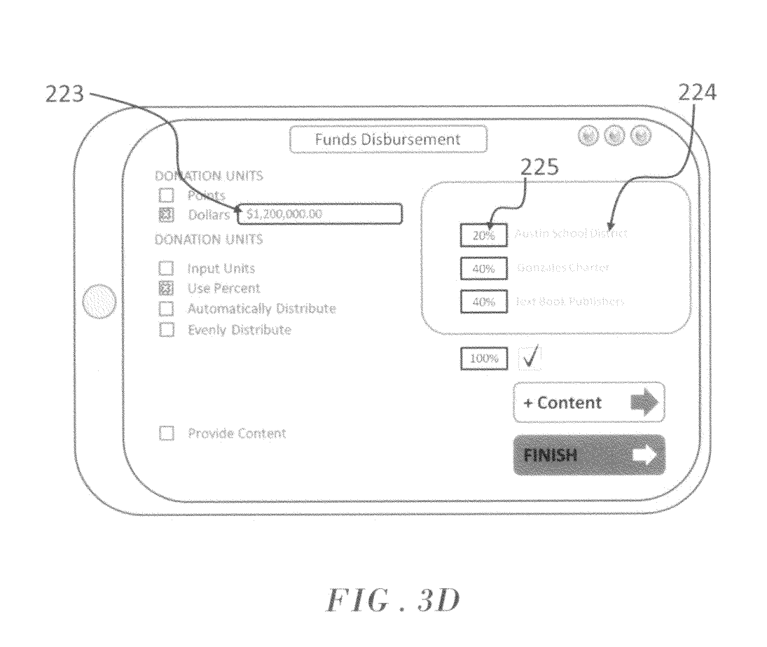

FIG. 3A

Referring to FIG. 3A, the drawings show the elements of a basic sponsorship system 10 which allows the donor 100 to first identify addressable tiers within a tiered organization 120 and profile members of discreet groups 150 within a specified tier.

When a supporter 100 uses a sponsorship system 10 governing a tiered organization 120 with a broad geography, it may be desirable to first reduce the size of the geography before applying a demographic filter 210. For instance, a sports equipment retailer may only have operations in the Austin, Tex. area and is interested in using their pledge 110 for their local community.

In the current example, the supporter 100 would start by keying a string search of “Texas School Systems,” and choosing “Select Tiers” which subsequently applies a first filter 210 against the data files 200. The interactive computer-implemented system would first return the formal designation of “Texas Department of Education” and offer a geographic selection drop down box. The supporter 100 then selects “Central Texas Depart. Of Education” to focus his pledge 110 targets to the Austin, Tex. community.

This still leaves an unmanageable directory of hundreds of potential public schools, charter schools and districts. In this example, the retailer is interested in placing seasonal interactive advertising in electronic textbooks for high schools. The sponsor 100 therefore uses the demographic profile system 220 to search individuals served 170 “Age 14-18” who are heavy “eTextbook Users.” This results in a list of discrete groups suggested 224.

The sponsor 100 selected all the suggested targets to create a list of discrete groups suggested and selected 224.

By next selecting “Continue”, the donor 100 confirms selections and transfers the discrete groups suggested and selected 224 to the next process, in FIG. 3D, of allocating the donation 110 into a donation split 140 across the remaining discrete groups 150.

FIG. 3B

FIG. 3B is a drawing showing the elements of a system for allocating fundraising 10 which allows the donor 100 to allocate donations 110 based on the profile of members of the discrete groups 150.

The computer-implemented interactive filter system 210 is used by the donor 100 by first running a general search. In this example, the donor 100 uses a free-form string search of “Texas School Systems” and selects the option for “Select Group Profile.” The filter 210 searches for an institution 130 matching the string and returns “Texas Department of Education” which is both a primary institution 130 to all Texas schools and a potential recipient 150 of donations 100 from a federal donor system 10 or supporters 100.

The donor 100 then selects the types of recipient 150 from a list comprising legally associated entities 151 such as public schools; outside recipients 152 such as charter schools; volunteers 160 such as educators 160; or individuals served 170 such as students 170. In this example, the donor 100 has selected “Free Public Schools” and “Charter Schools” as types of discrete groups 150 the donor 100 wishes to provide funds 110. However, these selections still show an unmanageable list of eight thousand five hundred schools so the donor 100 needs to apply a filter 210 that is able to identify schools with a high propensity of individuals served 170, such as students 170, matching the objectives of the donor 100. For this example, the donor 100 is interested in supporting students 170 with the characteristics they believe are indicative of children that will someday hold public office. As a result, the donor 100 selects the demographic profile 220 comprising of “Age 12-18” who attend both a “Business Club” and are involved in “Student Government.”

By selecting these characteristics, the donor 100 is not specifically targeting donations 110 to a discrete group 150, such as student government, but targeting the individuals who participate in discrete groups 150. For instance, there are no organizations which are comprised of both “Business Club” and “Student Government” combined, but there are individuals who match both characteristics. In contrast, fundraising systems 10 in the prior art would identify the receiving group 150 based on the characteristics of the organization. For the “Business Club” example, the prior art might identify the founding year; the numbers of student 170 members; the number of organizers 130; name and contact information for the senior administrator; budgets for prior years; percent of funds 110 spent on serving individual students 170; and awards or recognitions.

In the current FIG. 3B, the filter system 210 returns a list of seven discrete groups 150 within the data file 200 that match the demographic profile 220. Using the output of discrete groups suggested 224, the donor 100 selects two schools for donations 110.

By selecting “Continue”, the donor 100 captures the two selections and transfers the discrete groups suggested and selected 224 to the next step of allocating the funds 110 into a donation split 140 across the list of discrete groups 150 in FIG. 3D.

FIG. 3C

Turning to FIG. 3C is a drawing showing the elements of a demographic profile system 220 which allows the donor 100 to allocate contributions 110 based on the profile of the individuals served 170 or their surrogate 161.

The computer-implemented interactive filter system 210 is used by the donor 100 by first running a general search. In this example, the donor 100 uses a free-form string search of “Texas School Systems” and selects the option for “Select Demographics.” Instead of returning any primary institutions 130 to begin the filter 210, the filter system 210 shows the donor 100 a demographic profile system 220.

The first selection offered the donor 100 is to use a standardized indexing system which would simplify the selection process. For instance, if standardized index of “120.33.10” identified individuals living in a home with a household income under $25,000 per year and a female head of household, the donor 100 would be able enter the simplified score into the geodemographic score input 221 and no other selections would be required. The filter system 210 could identify those institutions 130, groups 150, affiliated groups 152, for profits 152, other legally associated entities 151, volunteers 160, or individuals served 170 within the data files 200 which match the index.

In the current example, the donor 100 does not select demographic score input 221 and moves to the next selection.

The second selection offers the donor 100 the opportunity to use a surrogate 161 of the individuals targeted. For instance, it might be undesirable, or illegal, for certain contributors 100 to target children for donations 110. As in the case of undocumented immigrants, a surrogate 161 would also be used in instances when demographics characteristics do not exist for a particular target. To avoid these issues, the donor 100 can target a surrogate 161, such as the parents of students, associated with target. In the current illustration, the donor 100 elects to use a surrogate 161 for the selection of the discrete groups 150 and moves on to selection of the surrogate's 161 demographic profile 220.

For the example FIG. 3C, the donor 100 then elects a demographic profile 220 comprising of “HH Income Under $25,000” and “Female Primary Head of Household” to target the children of the low-income, single, working mothers.

The filter system 210 responds by listing multiple recipient groups 150 within the tiered organization 120. At this point in the process, the donor 100 has been able to narrow a list of eight thousand five hundred potential recipients 150 to a manageable list of discrete groups suggested 224 that matches the donor's 100 specific donation 110 requirements.

The donor 100 then has the opportunity to select donor recipients 150 within the discreet groups suggested and selected 224 area of the form. In the current example, the donor 100 has select two beneficiaries 150.

By next selecting “Continue”, the donor 100 locks in the selections and transfers the discrete groups suggested and selected 224 to the next step of allocating the funds 110 into a donation split 140 across the remaining discrete groups 150, illustrated the next FIG. 3D.

FIG. 3D

Finally, turning to FIG. 3D, an example screenshot of the portion of the fundraising system 10 where the supporter 100 inputs allocated donated funds 223 of the donation split 140 to the discrete groups 150. The filter 210 in FIG. 3A, FIG. 3B, FIG. 3C and FIG. 3D generated a list of discrete groups 150 and passed the selected input 224 to this example screen for input of share split 140.

In addition to the systems and methods of fundraising previously discussed, the “Patent System for Allocating Fundraising” would then use the filtered and selected discrete groups 150 to create a list allowing for the input of the allocated donation funds 223 to only those discrete groups 150 remaining. In the present example, the donor 100 first selects if the donation 110 units would be dollars or another form of payment, such as points or substitute currencies. For the purposes of illustration, the donor 100 has selected they would provide donation splits 140 to the discrete group 150 in the form of currency. The donor 100 then keys the total amount of the donation 110 to the primary institution 130.

Continuing to utilize the computer-implemented interactive fundraising system 10, the donor 100 is presented with options for allocating the selected currency comprising of units of total dollars input, percent of the total dollars input, an automatic distribution based on the a weighted geodemographic profile, or to evenly distribute across the selected discrete organizations. In the example, the donor 100 has selected that they wish to allocate the donation among discrete groups 225 using the percent of total donation 110 to the parent institution 130. Incidentally, the example system 10 automatically tallies the total percent and marks that the total discrete donations 140 for the discrete groups 150 within the tiered organization 120 equal exactly one-hundred percent (100%) of the donation 110 amount designated for the organizer 130. This function is particularly important when donors 100 may not have the choice to allocate their entire donation 110 among their preferred discrete groups 150. For instance, the institution 130 may require a portion of the donation 110 be used for mandatory donation splits 140 or program fees.

It should be further understood that the funds 110 typically may be linked to sponsored content provided by the sponsor 100. The content could comprise a memorial message; identification of a group 150 or individual to be honored; logo for sponsor 100 identification; video messages; educational content; or advertisement for inclusion in materials viewed by volunteers 160 or individuals served 170 by the primary institution 130 or individuals served by the charity 170.

In this example FIG. 3D, the donor 100 has not elected to contribute content in association with the donation 110. This therefore completes the steps for targeting, identifying, selecting, and funding specific donor recipients 150 within the present fundraising system 10. As such, the donor 100 submits the current donation 110 process by clicking on “FINISH” button.

In the preferred embodiment, this submission causes the donation 110 to be submitted to the primary institution 130 to create the donation split 140 and distribute the donations 110 to the discrete groups 150.

In one embodiment of the present invention, as further illustrated in FIG. 1, the donor 100 can implement a second funds distribution system located on any funds distribution systems designated, or owned by, the contributor 100. In this embodiment, the donor 100 would not provide a lump sum donation 110 to the primary institution 130 with the tiered organization 120. Instead, the donor 100 contributes the associated contribution split 140 associated with each recipient 150 directly to the recipient 150. Recipients 150 could include discrete groups 150, legally associated entities 151, volunteers 160, volunteer surrogates 161, or specific individuals served 170 by the primary institution 130 or the discrete group 150.

Benefits, other advantages, and solutions to fundraising problems have been described herein with regard to specific embodiments. However, the advantages, elements, associated benefits, or specific solutions to problems are not to be construed as required, or essential, to any of the claims or the invention. It will be apparent to those skilled in the art that various modifications and variations can be made in the present invention without departing from the scope or spirit of the invention. As used herein, the terms “comprises”, “comprising”, or any other variation thereof, are intended to cover a non-exclusive inclusion, such that a process, method, article, or apparatus composed of a list of elements, that may include other elements not expressly listed or inherent to such process, method, article, or apparatus.

### Advantages

From the description above, a number of advantages become evident for the “System for Allocating Fundraising.” The present invention provides all new benefits for participating parties including donors, primary institutions, supported groups, and volunteers including:

Visibility of discrete groups associated with a primary institution.

Allowing automated support to groups associated the primary institution.

Allowing donor to target subgroups within the primary institution.

Combines the ability to provide contributions and automatically distributes those donations within divisions of the institution.

Allowing the use of filters to identify groups within the patent institution which meet donor requirements.

Allowing volunteers to receive specific benefits from donors, for example, free educational material.

What is claimed is:

1. A method for allocating donations in a computer network environment across groups associated with a primary institution, the method comprising:
a. collecting geodemographic information on members of discrete groups within a tiered organization;
b. storing in at least one database, by a computer-based system, geodemographic information on the members of discrete groups within said tiered organization;
c. accessing at least one said database;
d. applying at least one filter to generate a subset of the said database;
e. displaying the filtered subset;
f. selecting one or more discrete groups of the said filtered subset;
g. associating a donation with the groups selected.

2. A method of claim 1, wherein said members of a discrete group comprises volunteers.

3. A method of claim 1, wherein said members of a discrete group comprises surrogates for the volunteers.

4. A method of claim 1, wherein said members of a discrete group comprises individuals served by the group.

5. A method of claim 1, wherein said members of a discrete group comprises surrogates of individuals served by the group.

6. A method of claim 1, wherein said tiered organization comprises charities.

7. A method of claim 1, wherein said tiered organization comprises government entities.

8. A method of claim 1, wherein said tiered organization comprises a private enterprise.

9. A method of claim 1, wherein said database comprises geographical information.

10. A method of claim 1, wherein said database comprises demographic information.

11. A method of claim 1, wherein said database comprises group information.

12. A method of claim 1, wherein said filter comprises a demographic filter.

13. A method of claim 1, wherein said filter comprises a geographic filter.

14. A method of claim 1, wherein said filter comprises a group filter.

15. A method of claim 1, wherein said filters execute simultaneously.

16. A method of claim 1, wherein said donation comprises currency.

17. A method of claim 1, wherein said donation comprises substitute currency.

18. A method of claim 1, wherein said donation comprises a service.

19. A method of claim 1, wherein said donation comprises a property.

20. A system for allocating donations across groups associated with a primary institution, comprising: means for collecting information on members of discrete groups within a tiered organization; means for storing geodemographic information on the members of said discrete groups within said tiered organization; means for accessing said database; means for filtering said database to generate a subset of said database; means for displaying the filtered subset; means for selecting one or more discrete groups of the said filtered subset; means for associating a donation with said groups selected.
